(19) United States
(12) Patent Application Publication
(10) Pub. No.: US 2007/0059208 A1
(43) Pub. Date: Mar. 15, 2007

(54) Fluid processing device and integration with sample preparation processes

(75) Inventor: Sean M. Desmond, Moorpark, CA (US)

Correspondence Address: KILYK & BOWERSOX, P.L.L.C., 3603 CHAIN BRIDGE ROAD, SUITE E, FAIRFAX, VA, 22030, US

(73) Assignee: Applera Corporation, Foster City, CA (US)

(21) Appl. No.: 11/226,046

(22) Filed: Sep. 14, 2005

(51) Int. Cl. G01N 21/00

(52) U.S. Cl. 422/72; 422/57

(57) ABSTRACT

A fluid processing device comprises a substrate rotatable about a central axis of rotation and symmetrical about at least one centerline passing through the central axis of rotation, and the substrate comprises a plurality of channels, each channel comprising a respective inlet chamber and two or more respective outlet chambers. The chambers can include a plurality of individual, unconnected, input wells adapted to each receive a separate input of fluid. The channels can include flow splitters that divert at least a portion of fluid from a primary series of channels and chambers to a secondary series of channels and chambers. The diverting portions of the flow splitters can comprise at least a directional component parallel to the direction of centrifugal forces generated by rotating the substrate about its central axis of rotation. Diverting portions of flow splitters in channels on one side of the centerline can extend in a direction that is mirrored, with respect to the centerline, by diverting portions of flow splitters in channels on the opposite side of the centerline.

### INTRODUCTION

The present teachings relate to fluid handling assemblies, systems, and devices, and methods for using such assemblies, systems, and devices. The present teachings relate to fluid handling assemblies, microfluidic fluid handling assemblies, systems, devices, and methods that allow for the manipulation, processing, and other handling of fluids and fluid samples, for example, handling of micro-sized amounts.

### SUMMARY

According to various embodiments, the present teachings provide a fluid processing device, comprising a substrate rotatable about a central axis of rotation, and symmetrical about at least one centerline passing through the central axis. The substrate can comprise a plurality of chambers and a plurality of channels. The chambers can comprise one or more of inlet chambers, outlet chambers, reaction chambers, storage chambers, and the like. The chambers can be wells formed in the substrate. The channels can comprise a first set of channels arranged on a first side of the at least one centerline of the substrate and a second set of channels arranged on a second side of the at least one centerline of the substrate, opposite the first side. The channels of the first set of channels can be substantially parallel to each other. The channels of the second set of channels can be substantially parallel to each other. Each channel of the first set of channels can comprise at least one split passageway. A first portion of each split passageway can be adapted to direct fluid flow from an inlet of the first portion to an outlet of the first portion, in a first direction away from the centerline. Each channel of the second set of channels can comprise at least one second split passageway. A first portion of each second split passageway can be adapted to direct fluid flow from an inlet of the respective first portion to an outlet of the respective first portion, in a second direction away from the centerline. The first and second directions can mirror each other with respect to the centerline.

In some embodiments, the fluid processing device can comprise a substrate that can comprise a plurality of chambers, a plurality of channels, and a plurality of valves adapted to control fluid communication between the chambers and channels. The chambers can include a plurality of individual, unconnected input wells adapted to each receive a separate input of fluid. A primary series of chambers, channels, and valves can be arranged in line with each of the input wells, with each primary series including a flow splitter portion that can divert at least a portion of fluid that is directed along the primary series. The diverted portion can be diverted into a secondary series of chambers, channels, and optionally valves, arranged substantially parallel to the primary series. Each of the primary series of chambers, channels, and valves and associated secondary series can terminate in a respective output well. The output wells of the primary series can be arranged in a first row. The output wells of the secondary series can be arranged in a second row. The second row can be spaced from the first row, for example, spaced from and parallel to the first row.

According to various embodiments, the present teachings provide a method comprising spinning a fluid processing device comprising first and second sets of channels opposite each other with respect to a centerline, wherein each channel of the first set comprises a flow splitter that diverts a portion of a fluid moving through the respective channel in a first direction, each channel of the second set comprises a flow splitter that diverts a portion of a fluid moving through the respective channel in a second direction, and the first and second directions mirror each other with respect to the centerline. The method can also comprise aligning a plurality of sample extraction devices with an array of outlet chambers of the device; and extracting fluid from the outlet chambers. The sample extraction devices can comprise, for example, injectors of a plurality of respective capillaries of a capillary electrophoretic device, and the method can comprise disposing the plurality of injectors into an array of the outlet chambers. The fluid processing device can comprise a substrate rotatable about an axis of rotation that has a centerline passing through the central axis, a plurality of fluid processing pathways disposed in or on the substrate and arranged substantially parallel to each other, and a split passageway in each of the plurality of fluid processing pathways. A plurality of chambers can each be in fluid communication with each split passageway. All outlet chambers of the plurality of the fluid processing pathways of a set of channels can be arranged in an array or in a group of plural arrays. The outlet chambers can be disposed in a rectangular grid comprising at least two rows. In some embodiments, the method can comprise injecting a fluid disposed from at least one of the outlet chambers of an array of chambers and into at least one of a plurality of capillary injectors. The method can comprise performing electrophoretic analysis on a fluid after that fluid is extracted from an outlet chamber.

This arrangement can allow for a relatively low density of channels, chambers, and valves on the substrate, while providing input wells and output wells at a spacing that can be compatible with existing laboratory instruments, for example, capillary electrophoresis instruments, pipettes, aspirators, dispensers, or dispensing heads. An example of a capillary electrophoresis instrument that can be used according to some embodiments is the ABI PRISM® 3100-Avant Genetic Analyzer (the ABI 3100), from Applied Biosystems, Foster City, Calif., that can load samples from the outlet chambers or output wells, or dispense samples to the inlet chambers or input wells.

Additional features and advantages of the present teachings will be set forth in part in the description that follows, and in part will be apparent from the description, or may be learned by practice of the present teachings. The advantages of the present teachings will be realized and attained by means of the elements and combinations particularly pointed out in the description and appended claims.

It is to be understood that both the foregoing and general description and the following detailed description are exemplary and explanatory only and are intended to provide a further explanation of the present teachings.

### DRAWINGS

The skilled artisan will understand that the drawings, described below, are for illustration purposes only. The drawings are not intended to limit the scope of the present teachings in any way.

FIG. 1 is a top view of a fluid processing device according to various embodiments;

FIG. 2 is a perspective view of a system comprising a platen adapted to rotate a fluid processing device according to various embodiments;

FIG. 3 is an enlarged top view in partial cutaway of an arrangement of channels and chambers arranged in a fluid processing device according to various embodiments;

FIG. 4 is a perspective view of a fluid processing device according to various embodiments;

FIG. 5 is a perspective view of a fluid processing device according to various embodiments; and

FIG. 6 is a perspective view of a header comprising a plurality of capillary tubes aligned with a fluid processing device according to various embodiments.

It is to be understood that both the foregoing general description and the following detailed description are exemplary and explanatory only and are intended to provide a further explanation of the various embodiments of the present teachings.

### DESCRIPTION OF VARIOUS EMBODIMENTS

The present teachings provide a fluid processing device comprising an arrangement of channels, chambers, and valves that can accomplish integrated sample preparation within a fluid processing device. This can be exemplified with reference to a card-type fluid processing device comprising a substrate with channels, chambers, and valves formed therein and/or thereupon. The channels, chambers, and valves can be arranged on the card to make the card compatible with existing fluid dispensing, extracting, and/or injecting aspirating systems. This can reduce a density of channels, chambers, and valves on the substrate. This in turn can provide more space between features on a card. The extra space can facilitate operation of the valves on the card to control the flow of fluids through the channels and chambers.

In some embodiments, the fluid processing device can enable integration of several reactions within a single device. The channels and chambers can be arranged to perform a sequential series of reactions, for example, a Polymerase Chain Reaction (PCR) amplification, a PCR product purification process, a nucleic acid sequencing reaction, and a sequencing reaction product purification process. The function of the fluid processing device can utilize several technologies, including centrifugal fluid transfer, mechanically operated valves, thermal cycling, temperature monitoring of various channels and chambers, optical detection, luminescent detection, and fluorescence detection. The arrangement of individual channels that can each extend from a respective input chamber and can be placed into fluid communication with one or more respective output chambers, enables the production of one or more products per individual channel or pathway.

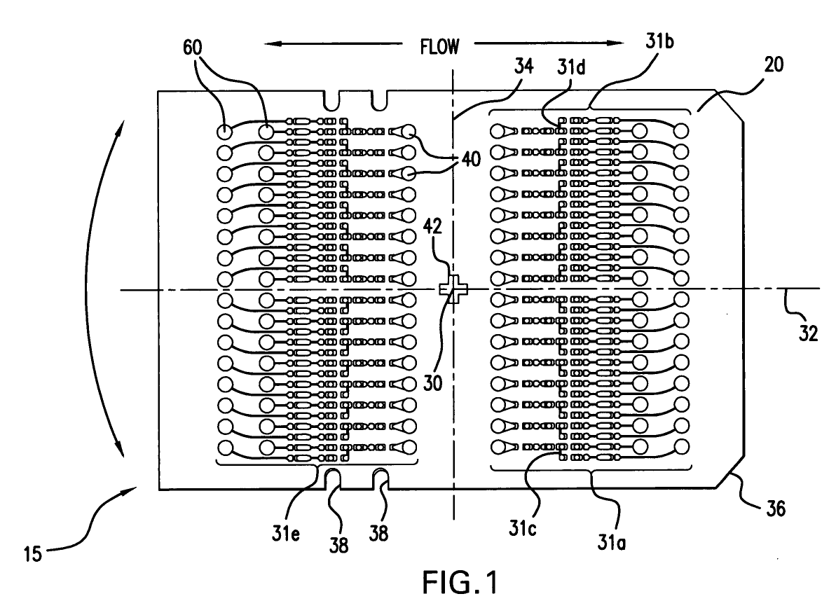

According to various embodiments, and as shown in FIG. 1, a fluid processing device 15 can comprise a substrate 20 adapted to be rotated around a central axis of rotation 30 such that fluids introduced into input chambers or wells 40 can be moved through a respective pathway 31a, 31b, or 31c. Upon spinning, the respective fluids can be progressively moved radially outward, optionally through a series of reaction chambers or wells, to output wells 60 located near the radially outer ends of substrate 20. Substrate 20 can comprise one or more chamfered corner 36, an alignment notch 38, and a shaft receptacle 42. Chamfered corner 36 can provide for correct orientation of fluid processing device 15 in an instrument. Alignment notch 38 can provide for alignment with subsystems of an instrument, for example, with one or more of a temperature control device, a deforming blade, and a valve actuator. The shaft receptacle 42 can compliment and/or engage a fluid processing device holder, for example, a shaft, a shaft with a thread, a cutout in a platen, one or more clips on a rotatable platen, or other means known in the art, that can be used to hold fluid processing device 15 in or on an instrument.

A centerline 32 can determine an orientation of a flow splitter 31c along its respective fluid processing pathway, as shown, the particular flow splitter indicated by reference numeral 31c is disposed along and makes up part of fluid processing pathway 31a. Similarly, centerline 32 can determine an orientation of a flow splitter 31d along fluid processing pathway 31b. Flow splitters 31c and 31d can split their respective pathways to form respective secondary series of fluid processing pathways in substrate 20, and each in a direction away from centerline 32. A division line 34 can determine an orientation for a layout of a set of fluid processing pathways, for example, sets of pathways 31a, 31b, or 31e. Each fluid processing pathway 31e can be disposed across division line 34 and can mirror a fluid processing pathway 31b. As shown, fluid processing pathways 31b can mirror fluid processing pathways 31a.

Input wells 40 can be arranged in rows, for example, on opposite sides of division line 34. Each input well 40 of a row of input wells can be spaced a fixed distance from adjacent input wells in the same row, for example, about nine mm or about 18 mm apart. Fluid processing device 15 can be rotated clockwise or counter-clockwise.

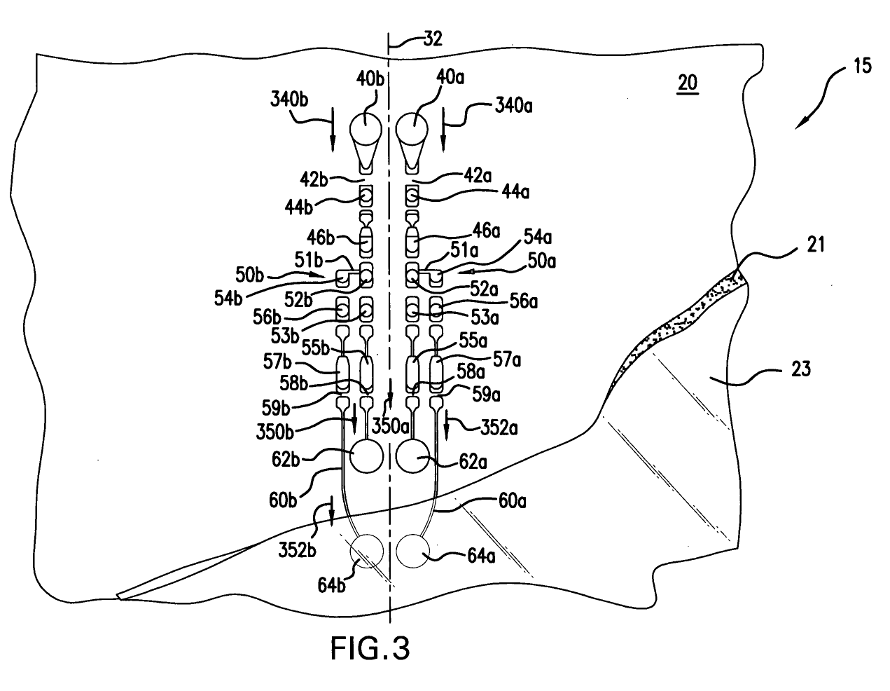

According to various embodiments, possible configurations for a fluid processing device can include, but are not limited to, a substrate comprising 32-output wells and a substrate comprising 64-output wells. The 32-output substrate can be configured into two sets or rows of output wells, for example, as shown in FIG. 1 and FIG. 3, with 16-output wells per set or row. According to various embodiments, and with reference to an exemplary embodiment designed to be compatible with the ABI 3100 mentioned above, output wells 60 can be spaced apart by 9.0 mm to allow direct loading of samples into the ABI 3100 capillary array.

According to various embodiments, a substrate comprising 64 output wells can also be configured with two sets or rows of 32 output wells each. In such a configuration, output wells 60 can be spaced apart by 4.5 mm in one direction and 9.0 mm in the other direction. The 4.5 mm spacing can be compatible with a 384-well microplate and can also be compatible with the ABI 3100 capillary array referred to above.

For each of the configurations described above, there can be half as many inputs as there can be outputs, for example, 16 inputs for 32 outputs or 32 inputs for 64 outputs. The spacing of the input wells can vary depending on a chosen configuration, for example, input wells 40 can be spaced apart by 9 mm when there are 16 inputs, and spaced apart by 4.5 mm when there are 32 inputs. Both spacing arrangements are compatible with existing multi-channel pipetters, injectors, dispensers, or aspirators, either manual or robotic, and can provide a customer or user with flexibility in setting up their reaction liquids. Additionally, a single-tip pipetter can be used with this device to allow a user to use only one of the many lanes or flow channels on the substrate.

As shown in FIG. 1 and FIG. 3, the fluid processing pathway or lane arrangement can be different depending upon a location of a fluid processing pathway with respect to the centerline and/or the division line of the substrate. For instance, the fluid processing pathways can comprise flow splitters that are different for fluid processing pathways on a first side of a centerline of the substrate in a first direction of rotation of the substrate compared to flow splitters for the fluid processing pathways on the opposite side of the centerline from the first side. This design can be used to take advantage of the direction of the centrifugal force generated at each location during rotation of the substrate. As the substrate is rotated about its center or central axis, centrifugal forces can radiate outwardly from the central axis, so the flow splitters in the fluid processing pathways can be disposed at an acute angle relative to lines radiating outward from the central axis.

As shown in FIG. 3, a first flow splitter 50a on a first side of centerline 32 of substrate 20 can comprise a channel 51a leading from an inlet 52a of first flow splitter 50a to an outlet 54a. Inlet 52a, as shown, is disposed closer to centerline 32 as compared to outlet 54a that is disposed farther away from centerline 32. A second flow splitter 50b on the opposite, second side of centerline 32 can comprise a channel 51b leading from an inlet 52b of second flow splitter 50b to an outlet 54b. As shown, inlet 52b is disposed closer to centerline 32 as compared to outlet 54b. This arrangement can result in flow splitters 50a and 50b mirroring each other with respect to centerline 32, for example, as shown, being approximately or substantially parallel to one another.

According to various embodiments, FIG. 3 is a top view of a portion of substrate 20 of a fluid processing device 15 that can be used to manipulate fluids, for example, micro-sized fluids and fluid samples, although larger features and fluid samples can be used. Herein, micro-sized fluids can refer to liquid volumes of about one milliliter (ml) or less. The substrate 20 can include a plurality of fluid and/or liquid-containment features formed therein or thereon, for example, a plurality of wells. The liquid-containment features can include reservoirs, recesses, channels, vias, appendices, input wells, ports, output wells, purification columns, valves, and combinations thereof, which can be interconnected and brought into fluid communication with each other, for example, by valves. Exemplary valves that can be used include deformable valves. The deformable valves, such as Zbig valves, can be arranged between the liquid-containment features to selectively control fluid communication between the liquid-containment features. Exemplary deformable valves that can be used are described in U.S. patent Applications No. 10/336,274, filed Jan. 3, 2003, and Ser. No. 10/625,449, filed Jul. 23, 2003, which are incorporated herein in their entireties by reference.

Greater details with regard to the structure and operation of deformable valves, the components of microfluidic devices, and the manipulation of fluid samples through microfluidic devices, are described in U.S. Provisional Patent Applications Nos. 60/398,851, filed Jul. 26, 2002, 60/399,548, filed Jul. 30, 2002, and 60/398,777, filed Jul. 26, 2002, and in U.S. patent application Ser. Nos. 10/336,274, 10/336,706, and 10/336,330, all three of which were filed on Jan. 3, 2003, in U.S. patent application Ser. No. 10/403,652, filed Mar. 31, 2003, in U.S. patent application Ser. No. 10/808,228 filed on Mar. 24, 2004, and in U.S. patent application Ser. No. 10/808,229, filed on Mar. 24, 2004. All of these provisional patent applications and non-provisional patent applications are incorporated herein in their entireties by reference. According to various embodiments, a device is provided that comprises a teardrop-shaped input chamber as described, for example, in U.S. patent application Ser. No. 10/336,706, filed Jan. 3, 2003.

According to various embodiments, and as shown in FIG. 3, substrate 20 can be at least partially formed of a deformable material, for example, an inelastically deformable material. Substrate 20 can include a single layer of material, a coated layer of material, a multi-layered material, or a combination thereof. Substrate 20 can be formed as a single layer and made of a non-brittle plastic material, for example, polycarbonate, or a cyclic olefin copolymer material, for example, TOPAS available from Ticona (Celanese AG), Summit, N.J., USA. The thermal conductivity of an exemplary TOPAS cyclic olefin copolymer can be about 0.16 Watt per meter Kelvin. Substrate 20 can be in the shape of a disk, a rectangle, a square, or any other shape. Substrate 20 can provide an operative surface for a thermal device to thermally contact fluid processing device 15.

According to various embodiments, an elastically deformable cover sheet 23 can be adhered to at least one of the surfaces of the substrate 20. Cover sheet 23 can be made of, for example, a plastic, an elastomer, or another elastically deformable material. According to various embodiments, cover sheet 23 and/or substrate 20 can be coated, for example, with a pressure sensitive adhesive 21. Fluid processing device 15 can include a central axis of rotation 30. A plurality of input liquid-containment features, referred to in an exemplary embodiment described below as input wells 40, and can be distributed on both sides of a centerline 32 of substrate 20. One or more fluids can be introduced into individual input wells 40, for example, by piercing through cover sheet 23, in an area of each input well 40 and injecting the one or more fluids into a respective input well 40. In other embodiments, the introduction of one or more fluids can comprise opening a valve, for example, by deforming an intermediate wall between two otherwise adjacent features. Processed fluid can be collected in output chamber 64a or 64b (FIG. 3) after moving through a respective pathway.

According to various embodiments, the fluid processing pathway can be arranged generally linearly. In various embodiments, and as shown in FIG. 1 and FIG. 3, more than one fluid processing pathway can be arranged side-by-side in or on substrate 20. A plurality of samples or a plurality of reactions on the same sample can be processed in the fluid processing device. The processing can be serial or simultaneous. For example, 2, 4, 6, 8, 12, 16, 24, 32, 48, 96, 192, 384, or more, fluid processing pathways can be arranged in or on fluid processing device 15. Moreover, one, two, four, or more sets of fluid processing pathways can be arranged on fluid processing device 15. One or more output chambers 60 (FIG. 1) can be provided for each fluid processing pathway.

According to various embodiments, and as shown in FIG. 3, a primary series 340a of channels, chambers, and valves on a first side of centerline 32 of substrate 20 can extend from an input well 40a that is disposed closer to the center (not shown) of substrate 20 as compared to the corresponding disposition of a flow splitter 50a that is disposed farther away from the center. If shown, the center would be near the top of the drawing in FIG. 3. Flow splitter 50a can divert a portion of a fluid flowing along primary series 340a to a secondary series 352a of chambers, channels, and/or valves, which can run substantially parallel to a downstream portion 350a of primary series 340a. The downstream portion 350a of primary series 340a can terminate in an output well 62a and the secondary series 352a can terminate in a respective output well 64a. An end channel portion 60a of secondary series 352a can curve toward primary series 340a and toward centerline 32, as shown in FIG. 1 and FIG. 3. The curve can allow disposition of output well 64a in-line with output well 62a.

According to various embodiments, and as shown in FIG. 3, primary series 340a of channels, chambers, and valves can comprise input well 40a, a valve 42a, a polymerase chain reaction (PCR) chamber 44a, a PCR purification well 46a, and flow splitter 50a. Flow splitter 50a can direct or divert a portion of a fluid from chamber 52a at an input end of flow splitter 50a through a channel 51a to a chamber 54a at a second output end of flow splitter 50a and in-line with secondary series 352a of chambers, channels, and valves. Channel 51a of flow splitter 50a can be angled away from centerline 32 in a direction having at least a directional component substantially parallel to division line 34 (FIG. 1) extending radially outward from center 30 of substrate 20. This disposition of channel 51a in flow splitter 50a can allow centrifugal forces generated by rotation of substrate 20 around center 30 (FIG. 1) to contribute to movement of a portion of the fluid along channel 511a from chamber 52a to chamber 54a. The portion of fluid in chamber 54a can then be moved into channels, chambers, and valves comprising secondary series 352a.

Downstream portion 350a of primary series 340a can comprise one or more chambers 53a and 55a. Downstream portion 350a can comprise a valve 58a formed in or on substrate 20, chambers for forward or reverse sequencing reactions, for example, chamber 53a, and/or for sequencing product purification, for example, chamber 55a, and an output well 62a. The secondary series 352a of channels, chambers, and valves can comprise one or more chambers 56a, and 57a, for further sequencing reactions and/or purification, and a valve 59a formed in or on substrate 20, and providing fluid chamber with corresponding output well 64a.

On the opposite side of centerline 32 of substrate 20, another primary series 340b of channels, chambers, and valves can comprise an input well 40b, a valve 42b, a PCR chamber 44b, a PCR purification well 46b, and a flow splitter 50b that can direct a portion of a fluid in a chamber 52b at an input end of flow splitter 50b through a channel 51b and into a chamber 54b a second output end of flow splitter 50b and in-line with a secondary series 352b of chambers, channels, and valves. Channel 51b of flow splitter 50b can be angled away from centerline 32 and with at least a directional component extending radially outward from center 30 of substrate 20, for example, substantially parallel to division line 34. Channel 51b of flow splitter 50b can extend in an opposite direction from an inlet to an outlet relative to centerline 32 relative to the direction of channel 51a of flow splitter 50a or, for example, the directions can mirror each other. This configuration can enable centrifugal forces generated by rotation of substrate 20 around center 30 to contribute to movement of fluids along channel 51b into secondary series 352b of channels, chambers, and valves.

Downstream portion 350b of the primary series 340b can comprise one or more wells 53b and 55b, and valve 58b can be formed in or on substrate 20 of fluid processing device 15 to provide chambers for forward or reverse sequencing reactions, and/or sequencing product purification. Primary series 340b can terminate in output well 62b. Similarly, secondary series 352b of channels, chambers, and valves can comprise one or more wells 56b and 57b, and valve 59b formed in or on substrate 20, and terminating in an output well 64b.

According to various embodiments, each series of liquid-containment features, as exemplified above and as illustrated in the drawings by a respective series of channels, chambers, and valves, along with an elastically deformable cover sheet 23 adhered over substrate 20 by an adhesive 21, can be arranged to define a plurality of fluid or liquid processing pathways. Input wells 40, 40a, and 40b, can be used to introduce or load one or more fluids into each of the separate fluid or liquid processing pathways. According to various embodiments, and as shown in FIG. 1, more than one liquid processing pathway can be arranged side-by-side (as shown) or radially (not shown) in or on substrate 20. A plurality of fluids or a plurality of portions of the same fluid can be processed in the liquid processing pathways. The processing can occur serially or simultaneously. One or more output wells or chambers can be provided for each liquid processing pathway, and each pathway can include one or more flow splitters. The various series can be arranged such that none of the series that are parallel to a radial centerline of the substrate fall on that radial centerline, as exemplified in FIGS. 1 and 3.

FIG. 1 and FIG. 3 show an elastically deformable cover sheet 23 that can be adhered to a surface of the substrate 20, for example, with a layer 21 of displaceable adhesive material. An exemplary liquid-containment feature such as input well 40a can be defined by the substrate 20 and the cover sheet 23. According to various embodiments, the layer 21 of displaceable adhesive material can be formed as part of the cover sheet 23. The displaceable adhesive material can be a soft material, for example, a hot melt adhesive or pressure sensitive adhesive, that can be formed on the cover sheet 23 or applied to the substrate before the cover sheet 23 is applied.

According to various embodiments, the displaceable adhesive material can hold and/or seal, two surfaces or layers together. The displaceable adhesive material can be a soft material, such as a plastic, for example, that can adhere the cover layer to the substrate. The displaceable adhesive material can become soft at an elevated temperature, for example, such as a hot melt adhesive. Exemplary displaceable adhesive materials can include resins, glues, adhesives, epoxies, silicones, urethanes, waxes, polymers, isocyanates, pressure sensitive adhesives, hot melt adhesives, combinations thereof, and the like. The displaceable adhesive material can be a silicone-based adhesive, disposed on a cover, for example, as provided as polyolefin cover tape, available from 3M, 3M Center, St. Paul, Minn., USA.

In various embodiments, selected features of the substrate can be increased in size. This can be a result of the decreased density of channels, chambers, and valves formed in or on the substrate having the above-described arrangement of channels, chambers, and valves. In one embodiment, for example, a mechanical valve structure such as valve 42a in primary series 340a can have a length of approximately 0.40 mm, and a width of at least about 1.5 mm. This arrangement can provide room for a correspondingly small valve-opening blade that can be used to deform substrate 20 at valve 42a to form a valve channel, for example, at a depth of about 60 microns, to thereby open-up a fluid communication between input well 40a and PCR well 44a.

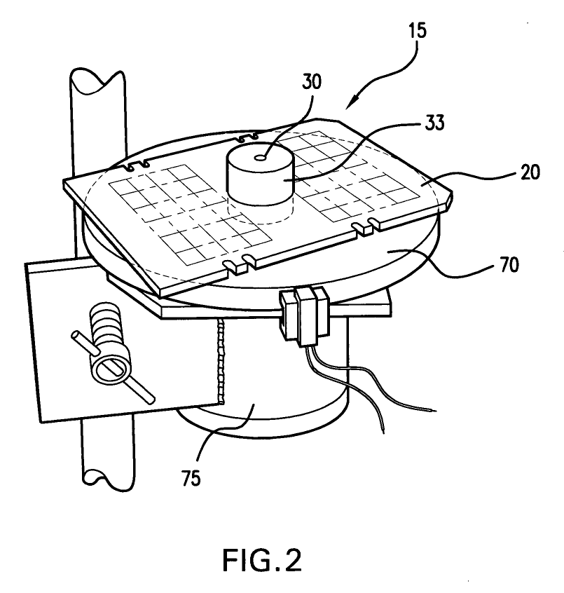

As shown in FIG. 2, a drive motor 75 can be located beneath a platen 70, on which fluid processing device 15 comprising substrate 20 can be mounted. Fluid processing device 15 can be attached to a spindle or shaft 33 of platen 70 using shaft receptacle 42 (see FIG. 1) disposed in fluid processing device 15 at center 30 of substrate 20. Fluid processing device 15 can be rotated about its center 30 by operation of drive motor 75. Rotation of fluid processing device 15 about its center 30 can generate centrifugal forces directed outwardly from center 30 of substrate 20. The force can be exploited to drive fluids from input chambers 40 in an outward direction through the flow passageways radially away from center 30 and the input chamber 40. Fluid communication with input chambers 40 can be established or interrupted by actuation of valves along the respective flow passageways, until the fluids reach output chambers 60. The flow passageways or channels can be arranged so that the centrifugal force on a fluid flowing in a channel can tend to keep the fluid against one side of the channel. This can provide clearance, allowing gases that may be trapped to escape down the channel past the fluid.

According to various embodiments, fluid processing device 15 can be rotated through center 30, to selectively force fluids between various chambers and channels of fluid processing device 15, by way of applying a centripetal force. For example, by spinning fluid processing device 15 around center 30, a fluid can be selectively forced to move from, for example, input chamber 40 to output chamber 60 along a fluid processing pathway. The fluid flow in the fluid processing pathway can be controlled by manipulation of valves disposed in or on substrate 20. According to various embodiments, platen 70 can comprise a fluid processing device holder (not shown) built-in the platen 70. The fluid processing device holder can be arranged to support and rotate fluid processing device 15. According to various embodiments, an axis of rotation of platen 70 can be coaxial with center 30 of fluid processing device 15.

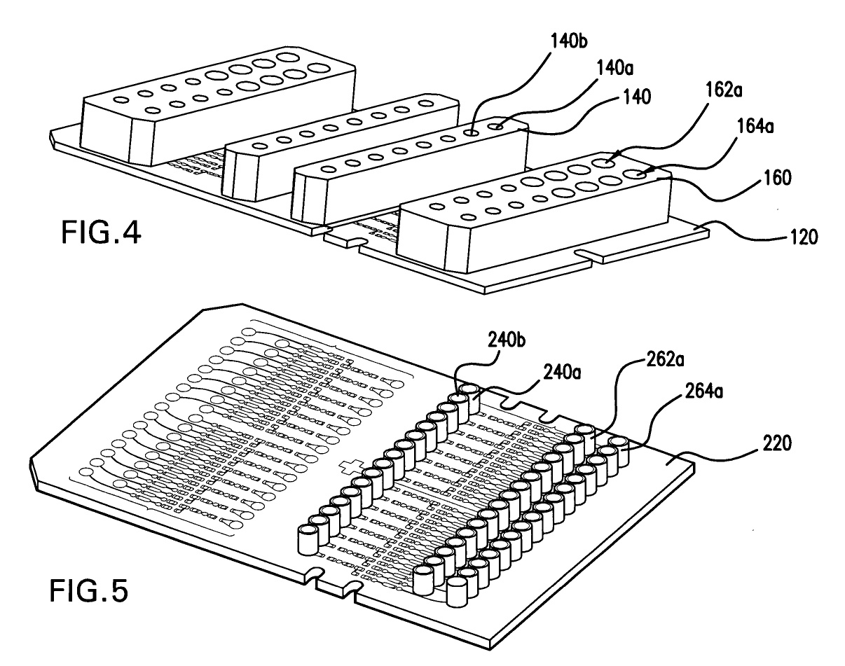

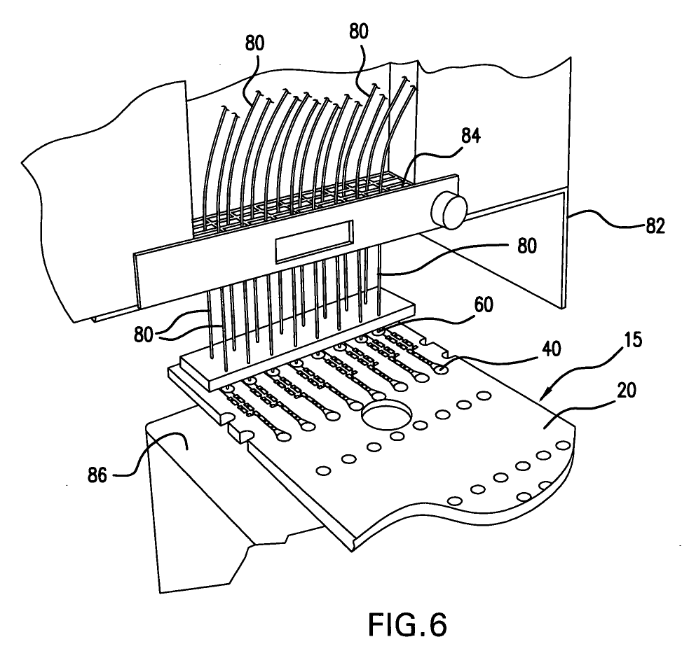

As shown in FIG. 4 and FIG. 5, and according to various embodiments, the output chambers can be formed as well as with additional depth to facilitate access by a liquid loading system, for example, a pipette, an injector, a robotic pipette, an aspiration tip, or a capillary. The output chambers can be disposed such that they align with a standard capillary array such as provided with the ABI 3100 or comparable instrument. The output chambers can be deep enough to accommodate a variability in positioning of the liquid loading system, for example, the tips of a capillary injection array. The output chambers can contain enough liquid or sample to enable sufficient electro-kinetic injection into a capillary. A similar situation can occur with the input chambers in that they can be designed to allow access by a multi-channel pipetter, whether under human or robotic control.

In the embodiment shown in FIG. 4, a substrate 120 can be provided with one or more output well regions 160 that can be of a greater thickness than surrounding portions of substrate 120. A row of output wells 162a and a row of output wells 164a can be formed in the one or more output well regions 160. Similarly, one or more input well regions 140 can be formed to have a greater thickness than the surrounding substrate and can comprise a row of input wells including wells 140a and 140b, defined in input well region 140.

According to various embodiments, and as shown in FIG. 5, the output chambers can comprise output wells arranged in two rows comprising, respectively, cylindrical end wells 262a and 264a disposed in and/or on substrate 220. Input wells 240a and 240b can be formed as respective cylindrical walls disposed in and/or on substrate 220.

The design and construction of the output chamber and input chamber features can vary depending on the technology used to fabricate the device. As an example, the entire component can be injection molded (in a single shot) from a cyclic olefin copolymer, for example, TOPAS.

As shown in FIG. 6, an injection array for a capillary electrophoresis instrument 82 (partially shown) can be positioned directly above the output chambers 60 formed on a substrate 20 of a fluid processing device 15, according to various embodiments. Instrument 82 can use a header 84 to maintain and/or align capillary injectors 80 in the capillary array shown. The capillary array can comprise a plurality of capillary injectors 80, for example, the 16 injectors shown, or about 24, about 32, about 48, about 96, about 192, about 384, or more, injectors. Fluid processing device 15 can be disposed on a platform 86. Platform 86 can comprise a fluid processing device holder and/or a rotatable platen.

According to various embodiments, the arrangement of output chambers 60 in fluid processing device 15 can be based upon 9.0 millimeter spacing utilized by microplates that are compatible with existing scientific instrumentation. Other standard pitches or spacings, for example, about 1.125 mm, about 2.25 mm, about 4.5 mm, or about 18.0 mm, can be used. An example of such a capillary electrophoresis instrument is the ABI PRISM® 3100-Avant Genetic Analyzer (ABI 3100) manufactured by the Applied Biosystems, Foster City, Calif. The autosampler in the ABI 3100 can accommodate a rectangular grid format of chambers or wells disposed in a substrate 20 according to various embodiments.

Other embodiments of the present teachings will be apparent to those skilled in the art from consideration of the present specification and practice of the present teachings disclosed herein. It is intended that the present specification and examples be considered as exemplary only.

What is claimed is:

1. A fluid processing device, comprising:
a substrate rotatable about a central axis of rotation and substantially symmetrical about a centerline passing through the central axis, the substrate comprising a plurality of channels, each channel comprising a respective inlet chamber and two or more respective outlet chambers in fluid communication with the channel, the channels comprising a first set of channels arranged on a first side of the centerline of the substrate and a second set of channels arranged on a second side of the centerline of the substrate opposite from the first side, the first and second sets of channels being substantially parallel to each other, and the first set of channels comprising at least one first split passageway, each first split passageway comprises a respective first portion and each first portion comprises a respective inlet and a respective outlet, each first portion of the at least one first split passageway is directed away from the centerline in a first direction from the respective inlet to the respective outlet, the second set of channels comprises at least one second split passageway, wherein each second split passageway comprises a respective first portion and each first portion comprises a respective inlet and a respective outlet, each first portion of the at least one second split passageway extends in a second direction from the respective inlet to the respective outlet, and the first and second directions mirror each other with respect to the centerline.

2. The fluid processing device of claim 1, wherein the number of input chambers is one half of the number of output chambers.

3. The fluid processing device of claim 2, wherein the inlet chamber of each channel is positioned closer to the central axis of rotation than the respective two or more outlet chambers.

4. The fluid processing device of claim 1, wherein each channel further comprising one or more reaction chambers disposed along the channel between the respective inlet chamber and the respective two or more outlet chambers, at least one of the one or more reaction chambers comprising at least one reaction component useful in one or more of a polymerase chain reaction, a nucleic acid sequence amplification reaction, purification process, a nucleic acid sequencing reaction, and a nucleic acid sequencing reaction purification process.

5. The processing device of claim 1, wherein each channel of the first and second sets of channels comprises one or more respective valves adapted to open, or open and close fluid communication through the respective channel.

6. The fluid processing device of claim 5, wherein the input wells are spaced from one another by a fixed pitch.

7. The fluid processing device of claim 5, wherein the fixed pitch comprises at least one pitch of about 1.125 mm, about 2.25 mm, about 4.5 mm, about 9.0 mm, and about 18.0 mm.

8. The fluid processing device of claim 5, wherein the one or more outlet chambers of each channel comprise a first outlet chamber and a second outlet chamber, the first outlet chambers of channels of the first set of channels are arranged in a first row, and the second outlet chambers of the channels of the first set of channels are arranged in a second row.

9. The fluid processing device of claim 8, wherein the first and second rows are substantially parallel to each other.

10. The fluid processing device of claim 8, wherein the first row is closer to the central axis of rotation than the second row.

11. The fluid processing device of claim 8, wherein the first row and the second row are aligned such that the first outlet chambers and the second outlet chambers are in the shape of a rectangular grid.

12. The fluid processing device of claim 1, further comprising a cover, wherein the substrate comprises a first surface and the cover is disposed in contact with the first surface, and the cover at least partially defines each of the plurality of channels.

13. The fluid processing device of claim 1, wherein each of the respective outlets of the respective first portions of the first split passageways and the second split passageways is in valved fluid communication with a respective one of the outlet chambers.

14. A system comprising the fluid processing device of claim 1 and:
a rotatable platen configured to rotate about a central axis of rotation; and
a device holder adapted to hold the fluid processing device to the rotatable platen.

15. The system of claim 14, further comprising a drive unit comprising a drive shaft, wherein the rotatable platen is mounted to the drive shaft and configured for rotation about its central axis of rotation.

16. The system of claim 14, further comprising a multiple sample extraction device, wherein the multiple sample extraction device comprises a plurality of sample extraction tips, and the plurality of sample extraction tips are arranged to align with a plurality of the one or more respective outlet chambers.

17. A method comprising providing a fluid processing device comprising:
a substrate rotatable about a central axis of rotation and substantially symmetrical about a centerline passing through the central axis, the substrate comprising a plurality of channels, each channel comprising a respective inlet chamber and two or more respective outlet chambers in fluid communication with the channel, the channels comprising a first set of channels arranged on a first side of the centerline of the substrate and a second set of channels arranged on a second side of the centerline of the substrate opposite from the first side, the first and second sets of channels being substantially parallel to each other, and the first set of channels comprising at least one first split passageway each first split passageway comprises a respective first portion and each first portion comprises a respective inlet and a respective outlet, each first portion of the at least one first split passageway is directed away from the centerline in a first direction from the respective inlet to the respective outlet, the second set of channels comprises at least one second split passageway, wherein each second split passageway comprises a respective first portion and each first portion comprises a respective inlet and a respective outlet, each first portion of the at least one second split passageway extends in a second direction from the respective inlet to the respective outlet, and the first and second directions mirror each other with respect to the centerline;
injecting a respective sample into the respective inlet chamber of each channel; and
spinning the fluid processing device about the central axis of rotation to move the respective samples or respective reaction products thereof from the respective inlet to the respective outlet of each respective first split passageway and each respective second split passageway.

18. The method of claim 17, further comprising opening a valve along each channel between the respective inlet chamber and the two or more respective outlet chambers.

19. The method of claim 17, further comprising:
aligning an injector array of a capillary electrophoretic device with at least a group of the outlet chambers; and
injecting respective ones of the samples or respective reaction products thereof from respective ones of the outlet chambers into the injector array.

20. The method of claim 19, further comprising performing electrophoretic separation of the respective samples or respective reaction products thereof after the injecting.
